(19) United States
(12) Patent Application Publication
(10) Pub. No.: US 2007/0175695 A1
(43) Pub. Date: Aug. 2, 2007

(54) Steering gear

(75) Inventors: Arthur Ernest Bishop, Hunters Hill (AU); Stuart Andrew Maxwell, East Ryde (AU)

Correspondence Address: BIRCH STEWART KOLASCH & BIRCH, PO BOX 747, FALLS CHURCH, VA, 22040-0747, US

(73) Assignee: dishop Steering Technology Limited, North Ryde (AU)

(21) Appl. No.: 10/571,897

(22) PCT Filed: Sep. 22, 2004
(86) PCT No.: PCT/AU04/01286

§ 371 Date: Feb. 9, 2007

(30) Foreign Application Priority Data
Sep. 22, 2003 (AU) 2003905143

(51) Int. Cl. B62D 5/04

(52) U.S. Cl. 180/444

(57) ABSTRACT

A rack and pinion steering gear (10) for a vehicle, wherein the steering gear (10) comprising an input shaft (18) rotatable about a first axis (50) and adapted to provide steering input to the steering gear (10), and a rack (12) laterally displaceable with respect to a steering gear housing (17). A pinion (14) laterally moveable with respect to the housing (17) substantially in a direction of travel of the rack (12) whilst engaged with the rack (12) thereby effecting a change in steering angle ratio. A swing arm (16) rotatable about a second axis (52) fixed with respect to the housing (17), the swing arm (16) having the pinion (14) journalled thereto, and the pinion (14) rotating about a third axis (54) fixed with respect to the swing arm (16). The first axis (50) being with respect to the housing (17).

### TECHNICAL FIELD

The present invention relates to a steering gear for a vehicle and in particular to a variable ratio steering gear for a vehicle.

### BACKGROUND

It is known to have a motor vehicle steering gear that is of a variable ratio type, that is, the steering gear allows the ratio between the angle of the steering input device (in most cases the steering wheel of the vehicle) and the angle of turn of the steered road wheels (in most cases the front wheels) to vary as a function of a given parameter. This ratio is hereinafter referred to as steering ratio. In a variable ratio rack and pinion steering gear, steering ratio is usually arranged to vary within the central region of the rack travel as vehicle speed increases so as to reduce the off centre steering sensitivity to steering inputs. Alternatively the steering ratio may alter along substantially the entire rack travel.

Several methods and devices are known that seek to achieve the aforementioned variability of steering ratio.

In one device, the mechanical components between the steered wheels and the steering input device have been removed and replaced with sensors and computer driven actuators. This type of device is often referred to as a “steer-by-wire” device, which may allow complete independent control of each steered wheel. There is concern however as to the absolute reliability of such devices, and one or more additional parallel systems may need to be employed to provide multilevel redundancy and thereby substantially lessen the possibility of a catastrophic malfunction occurring.

Another device for providing a variable ratio steering gear is depicted in International Publication No. WO02/36410 (Bishop). This patent specification discloses a traditional rack and pinion steering gear arrangement, whereby the driver retains direct mechanical control of the steered wheels. Variability of the steering ratio is achieved by laterally moving the pinion in a direction substantially parallel to the rack whilst the steering input is applied. The amount of lateral movement imparted to the pinion is based on both the magnitude of the steering input and at least one external parameter. The problem with this arrangement is that the angular steering input to the system is also required to move laterally with the pinion, thereby requiring the incorporation of a device that permits off-centre rotation such as a double-slider coupling or similar. Such devices are a possible source of mechanical backlash in the steering system.

Japanese Patent No 09-48364 (Koichi et al) discloses a variable ratio steering gear device having two racks and two pinions. A disadvantage of this system is the complexity of packaging and supporting two racks within the steering gear.

JP Patent Application No 2000-356595 (Kato et al) discloses a variable ratio steering gear device also based on a traditional rack and pinion steering gear arrangement. The ratio between the steering input device and the road wheels varies as a function of vehicle speed and the angle of turn from the on-centre position of the steered road wheels. Like the device described in WO02/36410 (Bishop), variability of steering ratio is achieved by lateral movement of the pinion along the rack. But, unlike WO02/36410 (Bishop), the pinion is mounted on a swing arm, which results in an arcuate movement of the pinion axis. This arrangement has the disadvantage of requiring a means to compensate for the lateral movement of the input shaft.

It is therefore an object of the present invention to provide a variable ratio steering gear for a vehicle that substantially ameliorates the problems of the prior art.

### SUMMARY OF INVENTION

According to a first aspect, the present invention consists in a rack and pinion steering gear for a vehicle, said steering gear comprising, an input shaft rotatable about a first axis and adapted to provide steering input to said steering gear, a rack laterally displaceable with respect to a steering gear housing, a pinion laterally moveable with respect to said housing substantially in a direction of travel of said rack whilst engaged with said rack thereby effecting a change in steering angle ratio, a swing arm rotatable about a second axis fixed with respect to said housing, said swing arm having said pinion journalled thereto, said pinion rotating about a third axis fixed with respect to said swing arm, characterised in that said first axis is fixed with respect to said housing.

Preferably said steering input is imparted to said pinion from said input shaft via a first transmission mechanism.

Preferably said first transmission mechanism is a gear set.

Preferably said first transmission mechanism is a belt or chain drive.

Preferably a second transmission mechanism imparts arcuate motion to said swing arm via a linkage means.

Preferably said second transmission mechanism comprises, a first shaft coupled with said pinion and rotatable about a fourth axis, said first shaft carrying a first pin offset from said fourth axis, said first pin slidably engageable with a substantially radial slot in a slot plate carried by a second shaft, said second shaft rotatable about a fifth axis and imparts drive to said linkage means which inturn imparts arcuate motion to said swing arm as a function of at least vehicle speed.

Preferably said second transmission comprises a gear set.

Preferably a motor drive imparts arcuate motion to said swing arm about said second axis.

Preferably said second transmission further comprises, a slot collar coupled and rotatable with said second shaft, said slot collar having a substantially diametrical slot disposed thereon, said diametrical slot slidably engageable with a second pin, the movement of said second pin controlled by an actuation means, said linkage means cooperating with said actuation means such that movement of said second pin alters the rate of rotation of said first shaft about said fifth axis.

Preferably said linkage means comprises one or more link members.

Preferably said third axis is coincident with said fourth axis.

Preferably said second axis is coincident with said fifth axis.

Preferably said rack has gear teeth of constant pitch.

Preferably said rack has gear teeth of variable pitch.

Preferably said rack has a Y-form cross section.

According to a second aspect, the present invention consists in a rack a pinion steering gear for a vehicle, said steering gear comprising, an input shaft rotatable about a first axis, said input shaft adapted to provide steering input to said steering gear, a rack laterally displaceable with respect to a steering gear housing, a pinion laterally moveable within said housing substantially in a direction of travel of said rack whilst engaged with said rack thereby effecting a change in steering angle ratio, a swing arm rotatable about a second axis fixed with respect to said housing, said swing arm having said pinion journalled thereto for rotation about a third axis, said second axis substantially at or near one end of said swing arm characterised in that said third axis is fixed with respect to said swing arm at or near its free end.

### BRIEF DESCRIPTION OF THE DRAWINGS

The present invention will now be described by way of example with reference to the accompanying drawings, in which:

FIG. 1 is a schematic perspective view of a preferred embodiment of a rack and pinion steering gear for a vehicle, in accordance with the present invention.

FIG. 2 is a schematic perspective view of the steering gear shown in FIG. 1, partly separated.

FIGS. 3a, 3b and 3c are views of the steering gear shown in FIG. 1, sectioned along III-III.

FIG. 4 is a graph of steering gear ratio versus steering wheel angle achieved by the steering gear shown in FIG. 1.

FIG. 5 is a schematic perspective view of a second embodiment of a rack and pinion steering gear for a vehicle, in accordance with the present invention.

FIG. 6 is a schematic perspective view of a third embodiment of a rack and pinion steering gear for a vehicle, in accordance with the present invention.

FIG. 7 is a schematic perspective view of a fourth embodiment of a rack and pinion steering gear for a vehicle, in accordance with the present invention, and

FIG. 8 is a schematic perspective view of a fifth embodiment of a rack and pinion steering gear for a vehicle, in accordance with the present invention.

For the sake of brevity and descriptive convenience in the following description, functionally similar components appearing in more than one figure bear common reference numerals in all of the figures, and their initial description made in respect to an earlier figure is generally not repeated in relation to a later figure.

### BEST MODE OF CARRYING OUT THE INVENTION

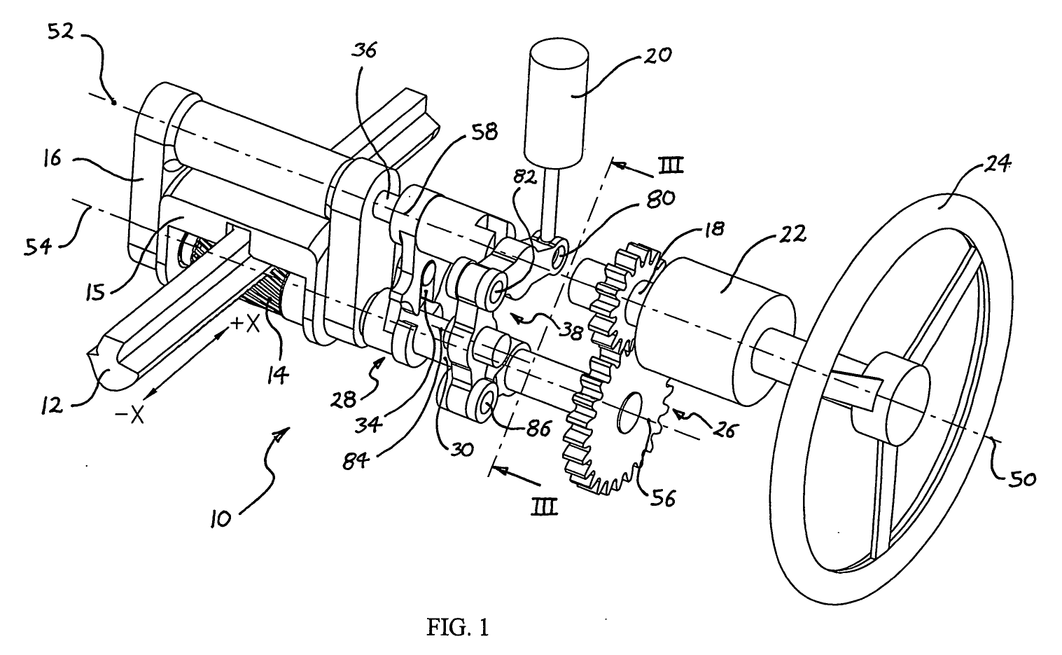

FIGS. 1, 2 and 3a-c depict a vehicle steering gear 10 in accordance with a first embodiment of the present invention.

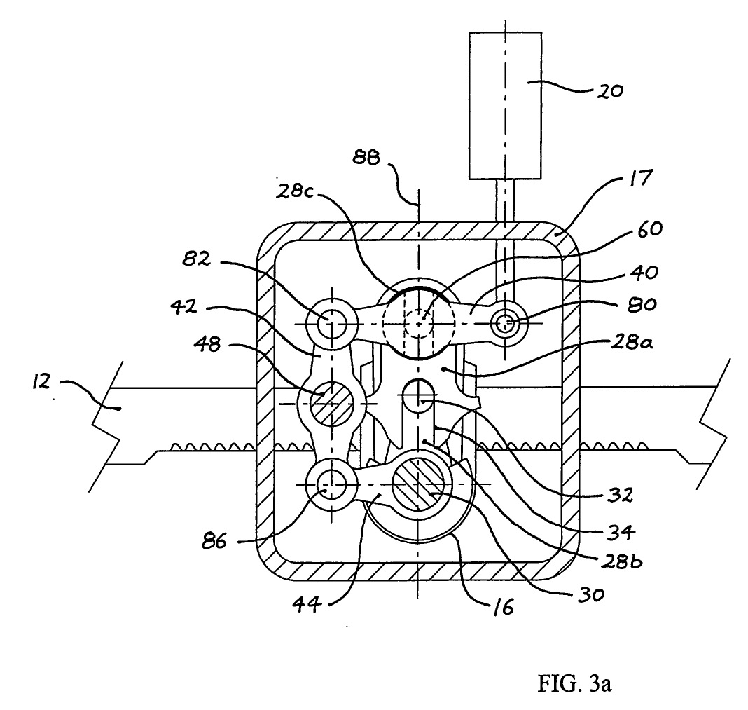

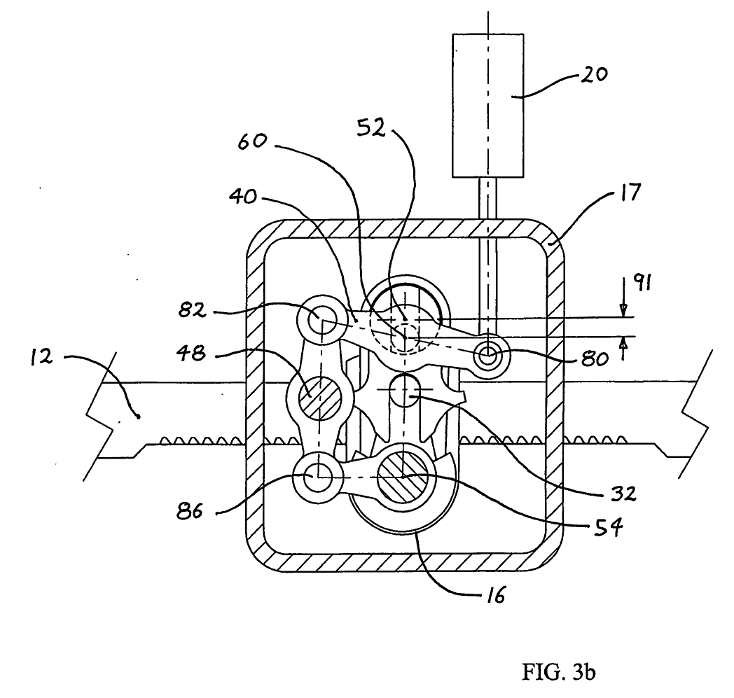

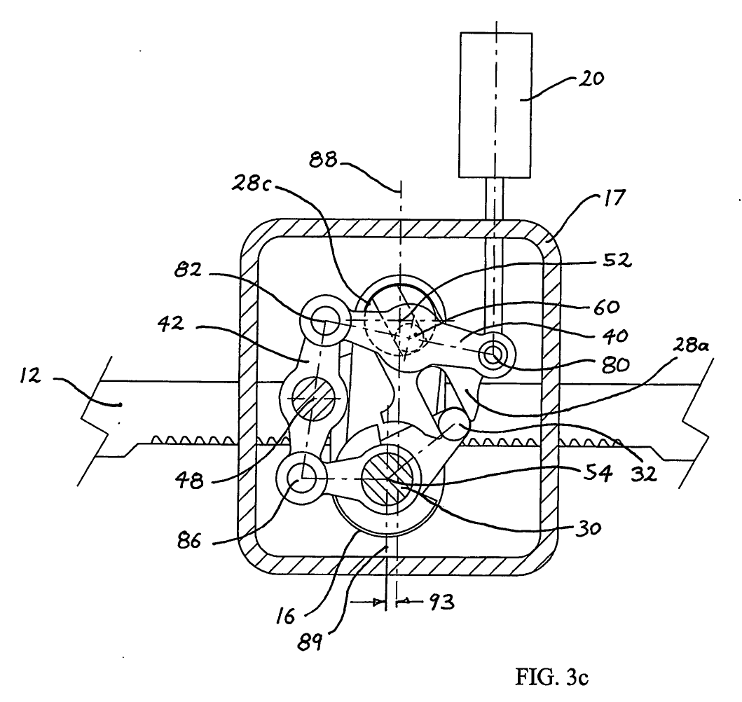

Steering gear 10 comprises rack 12 and pinion 14, tie rods (not shown) are conventionally placed at each end of rack 12, which inturn are pivotally connected to steering arms for each steered wheel (also not shown). Rack 12 is adapted to move laterally with respect to steering gear housing 17 (refer to FIGS. 3a-c).

Steering input is applied to steering gear 10 via steering wheel 24, the latter of which in FIG. 1 is shown for convenience as being directly connected by a common shaft to input shaft 18 of steering gear 10, but more usually is connected by an intermediate shaft employing Hookes joints to permit an angular offsets between the respective shafts. Input shaft 18 rotates about first axis 50 which is fixed with respect to housing 17 of steering gear 10.

Pinion 14 is journalled within a swing arm 16 for free rotation about a third axis 54. Swing arm 16 rotates about a second axis 52 and, in this embodiment, rack 12 utilises rack support 15 to constantly urge rack 12 into mesh with pinion 14 during arcuate movement of swing arm 16. Rack 12 is arranged to have the ability to float upwardly and downwardly within its own supports (not shown) during arcuate movement of swing arm 16, and thereby maintain backlash-free mesh with pinion 14 at all times. Pinion 14 receives rotational drive from first shaft 30 which inturn is driven by first gear set 26. First gear set 26 comprises first gear 26a and second gear 26b, the latter of which receives rotational input from steering wheel 24 via input shaft 18. Steering input torque and the angular position of input shaft 18 are measured by a torque and angle sensor 22, which is located coaxially with input shaft 18.

It can be seen from this arrangement that rotation of steering wheel 24 provides direct rotation of pinion 14 due to their mechanical relationship via first gear set 26 and first shaft 30.

Rotation of pinion 14 about third axis 54 creates lateral movement of rack 12 with respect to housing 17, in a direction dependent on the rotation of input shaft 18. The lateral movement of rack 12 can also be achieved by arcuate movement of swing arm 16 about second axis 52 even without rotation of pinion 14 about third axis 54. The arcuate movement of swing arm 16 about second axis 52 is determined by geneva mechanism 28 in association with linkage mechanism 38.

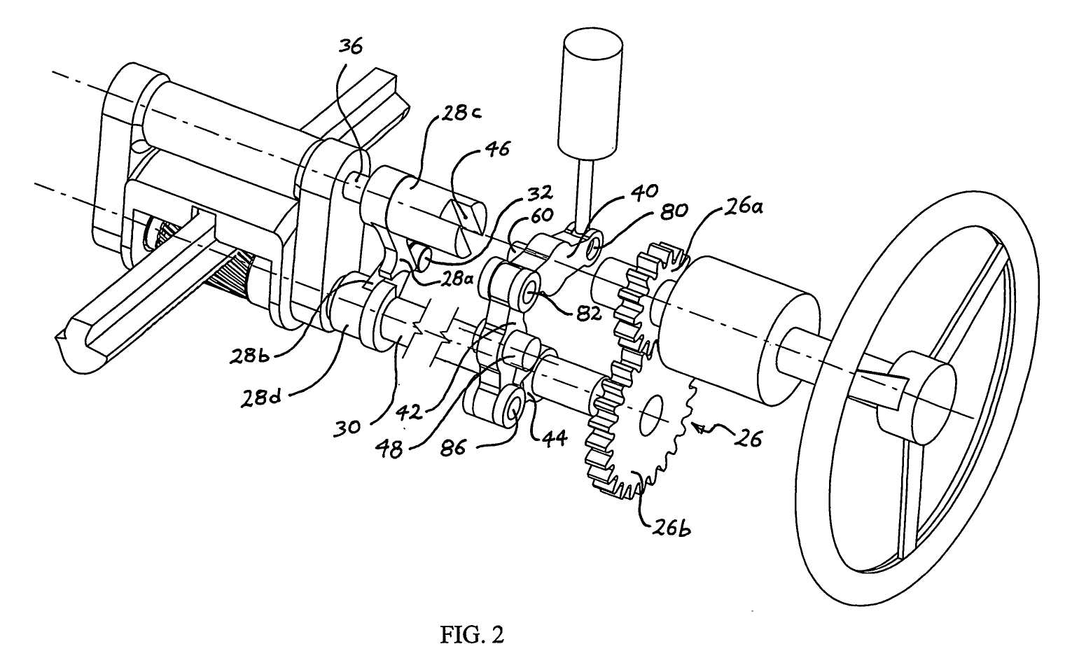

Geneva mechanism 28 comprises, slot plate 28a (see FIG. 2) having a radial slot 34 disposed thereon. Slot plate 28a radially extends from slot collar 28c, which is fixedly attached to second shaft 36 for rotation about fifth axis 58. In this embodiment fifth axis 58 is shown for convenience to be coincident with second axis 52. Radial slot 34 slidably cooperates with first pin 32, which perpendicularly extends from pin plate 28b. Pin plate 28b radially extends from a pin collar 28d, which is fixedly attached to first shaft 30 for rotation about a fourth axis 56, which is coincident with third axis 54. Therefore, as first shaft 30 rotates about fourth axis 56, it will drive slot plate 28a in an opposite direction about fifth axis 58 due to the geometric relationship of the components within geneva mechanism 28.

A substantially diametrical slot 46 is disposed on the axial periphery of slot collar 28c, which slidably engages second pin 60. The position of second pin 60 within diametrical slot 46 is determined by actuator 20 cooperating with linkage mechanism 38. Linkage mechanism 38 comprises first link 40 having first pivot joint 80 at one end and second pivot joint 82 at its other. Second pin 60 protrudes from first link 40 substantially at its centre. Actuator 20 is connected to first link 40 via first pivot joint 80 such that longitudinal displacement of actuator 20 rotates first link 40 and second pin 60 about second pivot joint 82. Second link 42 is connected to first link 40 through second pivot joint 82 and has fixed pivot 48 substantially at its centre and third pivot joint 86 at its other end. Third pivot joint 86 connects second link 42 to a third link 44. Third link 44 is journalled to first shaft 30 for rotation about fourth axis 56.

As mentioned earlier, first shaft 30 is rotationally driven by first gear set 26, which inturn receives its rotational input from input shaft 18. This arrangement allows second gear 26b, which is connected to first shaft 30 and coaxial with pinion 14, to rotate about first axis 50 whilst swing arm 16 executes its arcuate motion. Therefore, first axis 50 of input shaft 18 is able to maintain a fixed position whilst swing arm 16 executes its arcuate motion about second axis 52, this in turn effecting substantially lateral movement of third axis 54 and hence pinion 14.

The arcuate movement of swing arm 16 is determined by both the position of second pin 60 within diametrical slot 46 and by the amount of steering input that is being applied through input shaft 18. That is, if input shaft 18 is rotating, slot collar 28c will also rotate, due to its mechanical relationship through first gear set 26 and geveva mechanism 28. Slot collar 28c continues to rotate until first pin 32 completely leaves radial slot 34, wherein it maintains its angular position until first pin 32 returns and re-enters radial slot 34.

If, during the rotation of slot collar 28c, second pin 60 is positioned such that it is concentric with slot collar 28c (as shown in FIG. 3a), there will be no arcuate movement of the swing arm 16. But if, during the rotation of slot collar 28c, second pin 60 is positioned such that it is not concentric with slot collar 28c, swing arm 16 will begin to rotate. Furthermore, the amount of arcuate movement of swing arm 16 about second axis 52 will be determined by the degree to which second pin 60 is off-centre.

When second pin 60 is off-centre, rotation of slot collar 28c causes first link 40 to also rotate, which results in second link 42 rotating about fixed pivot 48.

Rotation of second link 42 about fixed pivot 48 applies a push (or pull) force to first shaft 30 via third link 44. This inturn rotates first shaft 30 and second gear 26b and swing arm 16, about second axis 52. Therefore arcuate movement of swing arm 16 about second axis 52 has occurred due to (a) the position of second pin 60 and (b) the steering input from steering wheel 24 via input shaft 18.

FIGS. 3a to 3c depict sectioned views of vehicle steering gear 10, and will hereafter be used to further explain the operation of linkage mechanism 38, in step form.

FIG. 3a depicts second pin 60 in a position concentric with slot collar 28c and second shaft 36. This represents a neutral position of this arrangement in that, rotation of slot collar 28c will result in no effect on first link 40 and therefore no arcuate movement of swing arm 16 about second axis 52 with steering input.

FIG. 3b depicts the situation in which actuator 20 has displaced second pin 60 downwardly by distance 91. No steering input has yet occurred via input-shaft 18 and therefore no arcuate movement of swing arm 16 about second axis 52 has resulted.

FIG. 3c depicts second pin 60 in the same position, with respect to slot collar 28c, as it was in FIG. 3b, but now there has been some steering input via input-shaft 18. First shaft 30 has rotated in a clockwise direction due to the steering input, which causes slotting collar 28c to rotate in an anti-clockwise direction. This inturn causes first and second links 40, 42 to rotate in a fashion as described previously. Third link 44 then pushes onto first shaft 30 and creates an anticlockwise rotation of swing arm 16 about second axis 52 and a corresponding substantially lateral displacement 93 of third axis 54 of pinion 14. Swing arm 16 has laterally displaced distance 93 relative to vertical axis 88 and housing 17. It should be understood that rack 12 would also displace in a lateral direction relative to housing 17 and axis 88 as a result of the initial rotation of pinion 14, but for simplicity has been left out of this analysis. Not shown in this figure is a slight rotation of actuator 20 due to a slight lateral movement of it connection to first link 40.

It should also be understood that continued steering input after the stage depicted in FIG. 3c, will result in no more arcuate movement of swing arm 16. This is due to first pin 32 leaving radial slot 34, thereby ceasing the rotation of slot collar 28c. The design of the components within geneva mechanism 28 result in slot plate 28a remaining locked in its angular position whilst pin plate 28b continues to rotate clockwise. Slot plate 28a will only begin to return to its original neutral position when first pin 32 returns to re-enter radial slot 34, that is, on the return path when first shaft 30 is rotating anti-clockwise.

It should be understood that although diametrical slot 46, is described above and shown in FIGS. 1, 2 and 3a-c as a straight slot, it may alternatively be a slightly curved slot.

Linkage mechanism 38 may comprise more or less linking members performing the same function, i.e., providing a mechanical connection between the position of second pin 60 and the angular position of first shaft 30 with respect to fifth axis 58.

The arrangement shown in FIGS. 1, 2 and 3a-c allows for a rack and pinion steering gear with an alterable steering gear ratio R (ratio between the steering input and the amount of lateral rack travel), within the lateral movement constraints of swing arm 16 about second axis 52. This is achieved by actuator 20 altering distance 91 to effect the change the steering gear ratio.

Steering gear ratio may be expressed as:

$$R = \frac{ⅆ θ}{ⅆ x}$$

wherein:
R=steering gear ratio
dθ=amount of steering angle input to steering gear 10 via input-shaft 18 (deg), and
dx=amount of lateral displacement of rack 12 (mm).

Therefore the steering gear ratio R has the units “deg/mm”. It is important to distinguish this definition of “steering gear ratio” R and the earlier referred to “steering ratio”. Steering ratio, as mentioned at the start of this specification, is dimensionless (ie. it has units “deg/deg”) and, although being partially determined by the steering gear ratio (R), is also influenced by the geometry of the steering linkages to the steered wheels ie. the front-end steering and suspension geometry in most vehicles. Under normal driving conditions, it is desirable to have a steering gear ratio R that alters as the vehicle speed changes, that is, the higher the vehicle speed, the higher the steering gear ratio required around the central region of the rack. If for example, a vehicle was travelling at high speed on a freeway, it is desirable to have a less lateral movement of the rack off centre for a given steering angle input and therefore a high steering gear ratio would be desirable. At low driving speeds, for example during parking, it is desirable to have a lower steering gear ratio, where a much larger steering output may be required to maneuver the vehicle.

A mechatronic control system (not shown) may be used for control of actuator 20 and the corresponding value of distance 91. It would control actuator 20 to displace second pin 60 as a function of at least vehicle speed. Other parameters that may be used in conjunction with vehicle speed include, for example, steering angle input and/or vehicle chassis parameters such yaw angle, lateral acceleration and/or longitudinal acceleration/deceleration. External parameters may also be provided as inputs to the mechatronic control system including, sensed parameters such as the existence of rain on the road (measured by a windshield sensor), or driver selected parameters such dashboard “personal preference” settings (eg. “sports” or “normal” mode).

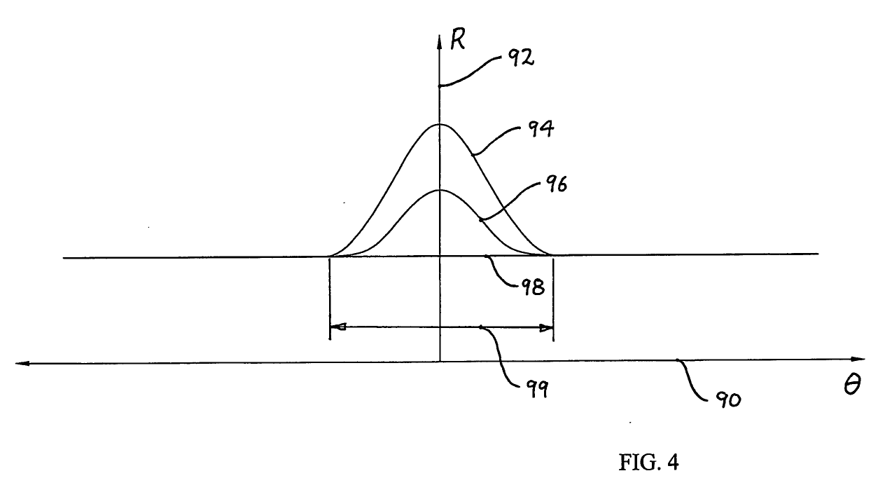

FIG. 4 shows a relationship between steering gear ratio R and steering wheel angle θ achievable by steering gear 10. Horizontal axis 90 represents steering wheel angle θ measured in deg at input-shaft 18, and vertical axis 92 represents the steering gear ratio R in deg/mm.

It can be seen that outside the central region 99 of steering wheel angle θ travel, the steering gear ratio R remains constant. Within the central region, three different relationships are represented, which correlate to three different values for distance 91 on FIG. 3b.

Assuming that the only parameter that influences actuator 20 control is vehicle speed, curves 94, 96 and 98 will represent steering gear ratio R at three different vehicle speeds, with curve 98 ideally representing the lowest speed, and curve 94 ideally representing the highest speed. Curve 98 represents a zero value of distance 91 (FIG. 3b) and no arcuate movement of swing arm 16 about second axis 52 would occur in this case.

It is important to note that unlike the steering gear disclosed in JP Patent Application No 2000-356595 (Kato et al), first axis 50, about which input shaft 18 rotates, is fixed with respect to housing 17. This overcomes the problem of providing a connection to the steering column that accommodates the lateral movement of the input shaft.

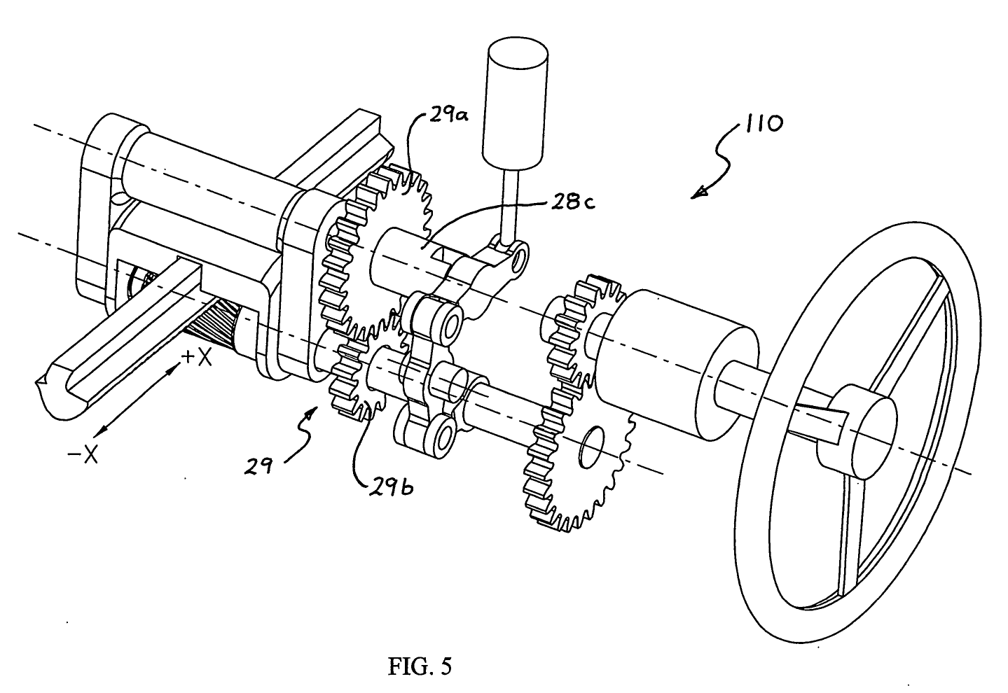

FIG. 5 shows steering gear 110 according to a second embodiment of the present invention. This embodiment differs from steering gear 10 of the first embodiment in that, geneva mechanism 28 has been replaced by second gear set 29. Second gear set 29 comprises third gear 29a and fourth gear 29b. Unlike steering gear 10, second gear set 29 allows slot collar 28c to continue to rotate with the “full range” of rotation of first shaft 30. This continuous rotation results in the ability of steering gear 110 to vary the steering gear ratio over the full range of steering wheel angle θ, rather than only within the centre region.

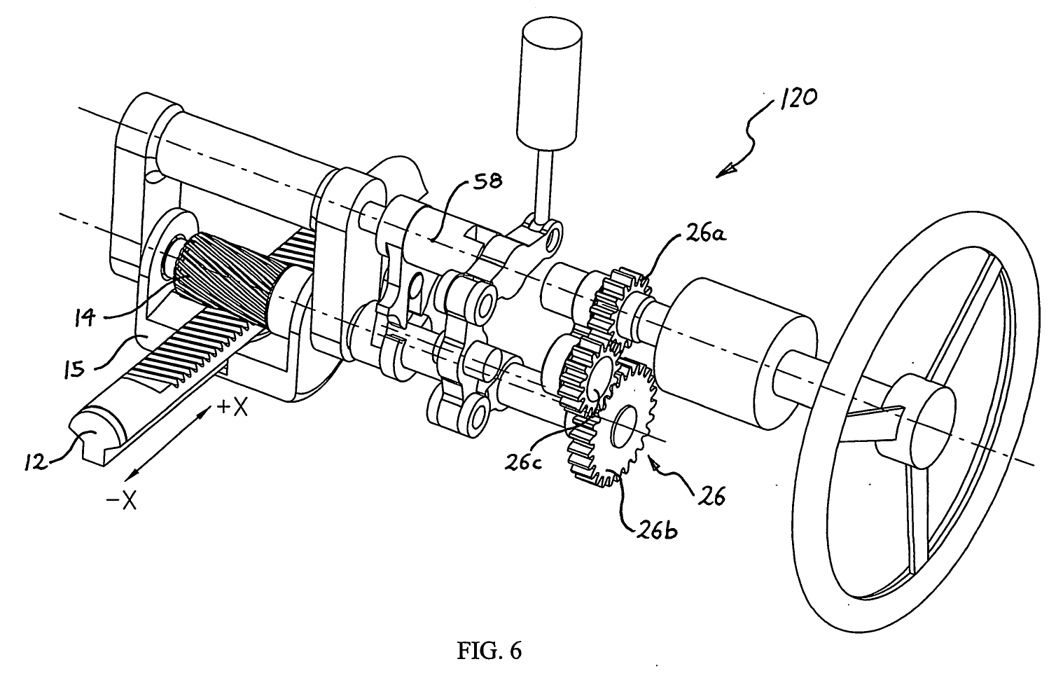

FIG. 6 shows steering gear 120 according to a third embodiment of the present invention. This embodiment differs from steering gear 10 of the first embodiment in that first gear set 26 now comprises three gears instead of two. Idler gear 26c has been added to allow rack 12 to be placed under pinion 14 instead of above (due to the reversed rotation of pinion 14). This is necessary in order to ensure that, for example, a clockwise rotation of input-shaft 18 generates lateral movement to the left (out of page in FIG. 6) of rack 12, and vice versa. It should be understood that idler gear 26c has a mounting means (not shown) that allows it's axis to move with first shaft 30 about fifth axis 58. Rack support 15 is repositioned to perform the same function as it did in earlier embodiments.

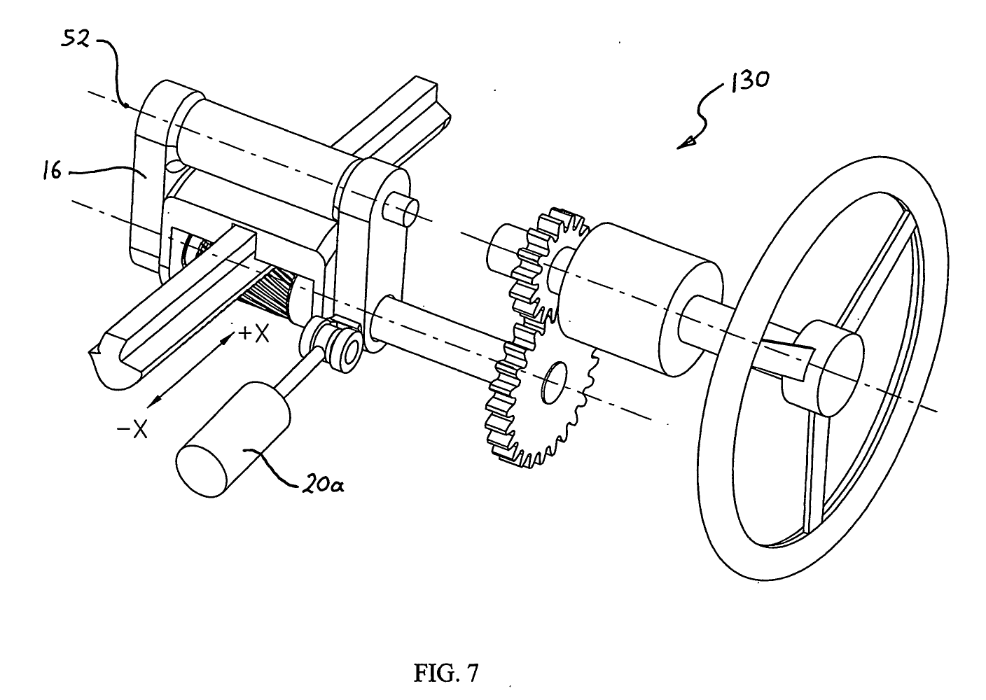

FIG. 7 shows steering gear 130 according to a fourth embodiment of the present invention. In this embodiment, linkage mechanism 38, actuator 20 and geneva mechanism 28 have been eliminated. Actuator 20a has been added and positioned so as to directly act to generate arcuate movement of swing arm 16 about second axis 52. Alternatively some other actuation means may be used to control swing arm 16 rotation directly. Like the second embodiment (shown in FIG. 5) steering gear 130 has the ability to vary steering gear ratio over the full range of steering wheel angle θ. It should be understood that actuator 20a may act upon swing arm 16 either directly or via another gear or linkage mechanism. Actuator 20a may be used not only to vary the steering gear ratio of steering gear 130, but also to produce an effective “steering gear offset”. That is, lateral motion of rack 12 can be generated without any associated rotation of input shaft 18. With suitable chassis and external sensors and associated software, this additional functionality can be used to allow steering gear 130 to compensate for external disturbances on the vehicle's trajectory due to, for example, cross-winds and changes in road camber.

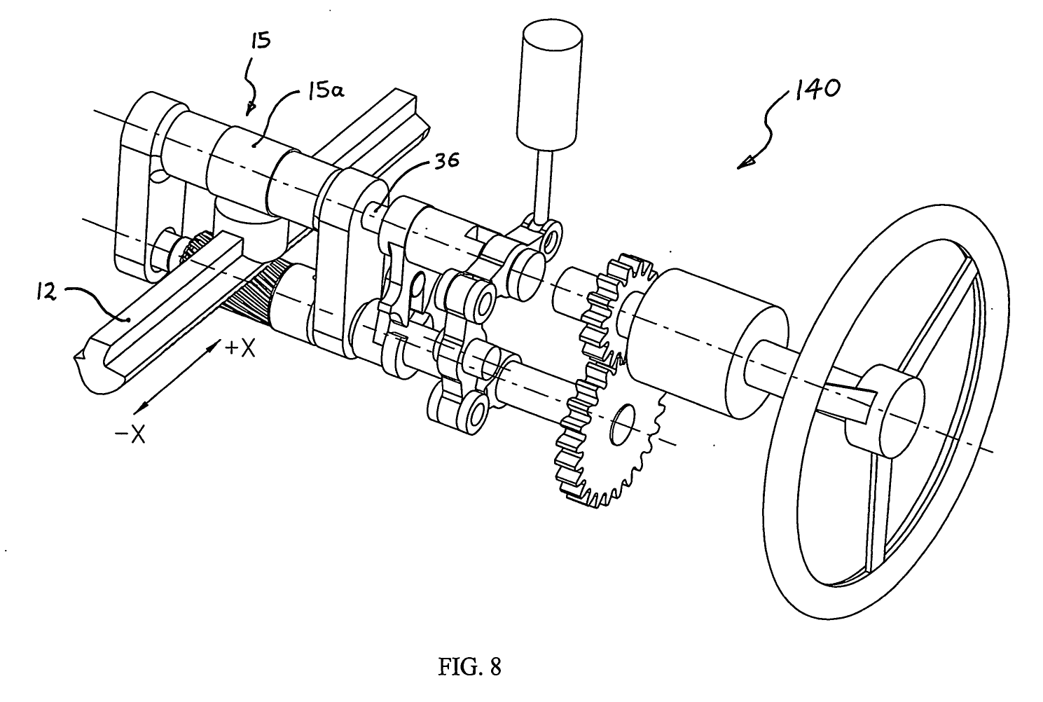

FIG. 8 shows steering gear 140 according to a fifth embodiment of the present invention. In this embodiment, rack support 15 now comprises cam 15a which rotates with second shaft 36, thereby maintaining a support load on rack 12. It should be understood that rack support 15 may take other forms without departing from the scope of the invention.

In the preceding embodiments, pinion 14, which rotates about a third axis 54, is directly coupled and coaxial, with a first shaft 30, but in other not shown embodiments pinion 14 and first shaft 30 may be coupled via a gearing means or drive belt, this arrangement necessitating third axis 54 and fourth axis 56 to be parallel and mutually offset rather than collinear as shown.

Also, in the preceding embodiments, steering input is derived from steering wheel 24, but in other not shown embodiments, steering wheel 24 may be a lever or a computer controlled motor drive.

The direction of rack 12 travel assumes that the steering gear of the preceding embodiments, are mounted behind the steered wheels. Alternatively rack 12 travel may be reversed and the steering gear mounted ahead of the steered wheels.

Rack 12 is shown in FIGS. 1-8, as a ‘Y’ form rack, which may be produced using the method described in U.S. Pat. No. 5,862,701 (Bishop et. al.). Alternatively rack 12 may be a conventional ‘D’ shaped rack cross section or any other suitable cross-section. Rack 12 is also shown as having a constant tooth pitch (FIGS. 3a-c). Alternatively rack 12 may have a tooth pitch that varies along its axis according geometry known in the art.

The aforementioned description relates to a variable ratio steering gear which is suited to both hydraulic and electric assisted power steering systems, both of which are based, on substantially the same construction.

It should also be understood that for reasons of clarity, various housings, supports, journals, bearings and control units have been omitted from the figures.

Although the present invention has been described in five embodiments, it is recognised that departures may be made from the embodiments without departing from the scope of the invention.

The term “comprising” as used herein is used in the inclusive sense of “including” or “having” and not in the exclusive sense of “consisting only of”.

1. A rack and pinion steering gear for a vehicle, said steering gear comprising, an input shaft rotatable about a first axis and adapted to provide steering input to said steering gear, a rack laterally displaceable with respect to a steering gear housing, a pinion laterally moveable with respect to said housing substantially in a direction of travel of said rack whilst engaged with said rack thereby effecting a change in steering angle ratio, a swing arm rotatable about a second axis fixed with respect to said housing, said swing arm having said pinion journalled thereto, said pinion rotating about a third axis, characterised in that said first axis is fixed with respect to said housing.

2. The rack and pinion steering gear as claimed in claim 1, wherein said steering input is imparted to said pinion from said input shaft via a first transmission mechanism.

3. The rack and pinion steering gear as claimed in claim 2, wherein said first transmission mechanism is a gear set.

4. The rack and pinion steering gear as claimed in claim 2, wherein said first transmission mechanism is a belt or chain drive.

5. The rack and pinion steering gear as claimed in claim 1, wherein a second transmission mechanism imparts arcuate motion to said swing arm via a linkage means.

6. The rack and pinion steering gear as claimed in claim 5, wherein said second transmission mechanism comprises, a first shaft coupled with said pinion and rotatable about a fourth axis, said first shaft carrying a first pin offset from said fourth axis, said first pin slidably engageable with a substantially radial slot in a slot plate carried by a second shaft, said second shaft rotatable about a fifth axis and imparts drive to said linkage means which inturn imparts arcuate motion to said swing arm as a function of at least vehicle speed.

7. The rack and pinion steering gear as claimed in claim 5, wherein said second transmission comprises a gear set.

8. The rack and pinion steering gear as claimed in claim 1, wherein a motor drive imparts arcuate motion to said swing arm about said second axis.

9. The rack and pinion steering gear as claimed in claim 6, wherein said second transmission further comprises, a slot collar coupled and rotatable with said second shaft, said slot collar having a substantially diametrical slot disposed thereon, said diametrical slot slidably engageable with a second pin, the movement of said second pin controlled by an actuation means, said linkage means cooperating with said actuation means such that movement of said second pin alters the rate of rotation of said first shaft about said fifth axis.

10. The rack and pinion steering gear as claimed in claim 5, wherein said linkage means comprises one or more link members.

11. The rack and pinion steering gear as claimed in 6 wherein said third axis is coincident with said fourth axis.

12. The rack and pinion steering gear as claimed in 6 wherein said second axis is coincident with said fifth axis.

13. The rack and pinion steering gear as claimed in claim 1, wherein said rack has gear teeth of constant pitch.

14. The rack and pinion steering gear as claimed in claim 1, wherein said rack has gear teeth of variable pitch.

15. The rack and pinion steering gear as claimed in claim 1, wherein said rack has a Y-form cross section.

16. A rack and pinion steering gear for a vehicle, said steering gear comprising, an input shaft rotatable about a first axis, said input shaft adapted to provide steering input to said steering gear, a rack laterally displaceable with respect to a steering gear housing, a pinion laterally moveable within said housing substantially in a direction of travel of said rack whilst engaged with said rack thereby effecting a change in steering angle ratio, a swing arm rotatable about a second axis fixed with respect to said housing, said swing arm having said pinion journalled thereto, said pinion rotating about a third axis, said second axis substantially at or near one end of said swing arm characterised in that said third axis is located at or near the free end of said swing arm.
